(19) United States
(12) Patent Application Publication
(10) Pub. No.: US 2005/0149631 A1
(43) Pub. Date: Jul. 7, 2005

(54) Safety Modbus Protocol

(75) Inventor: Bruce Michael Decker, Barrington, NH (US)

Correspondence Address: SQUARE D COMPANY;INTELLECTUAL PROPERTY DEPARTMENT, 1415 SOUTH ROSELLE ROAD, PALATINE, IL, 60067, US

(73) Assignee: SCHNEIDER AUTOMATION SAS, Sophia Antipolis (FR)

(21) Appl. No.: 10/707,721

(22) Filed: Jan. 7, 2004

(51) Int. Cl. G06F 15/16

(52) U.S. Cl. 709/230

(57) ABSTRACT

A protocol for communication between automation devices and a method for communicating between automation devices is disclosed. The protocol is an enhancement to the Modbus/TCP protocol, and includes a CRC-32 and time stamp fields at the application layer to increase the assurance of the message integrity. This increased integrity in network messages is critical in the operation of safety system.

### CROSS REFERENCE TO RELATED APPLICATIONS

This application is related to commonly owned U.S. patent application Ser. No. 09/611,648, entitled “PROGRAMMABLE LOGIC CONTROLLER WITH PROVISIONS FOR SAFETY SYSTEMS”, filed Jul. 7, 2000. This application is hereby incorporated by reference.

### BACKGROUND OF INVENTION

1. Technical Field

The present invention relates to the use of communications protocols in factory automation, such as Ethernet network protocols for connecting programmable logic controllers, with provisions for safety systems.

2. Background of the Invention

In a factory automation system, such as those in a nuclear power plant, manufacturing or petrochemical plant, the assurance of delivery of a message is critical to safe operation. As Ethernet protocols, which were originally developed for office automation markets, are moved into critical factory applications, new techniques need to be developed to assure the safety of the communication and control systems. Since network communications can never be fully guaranteed, provisions must be implemented to detect network errors and notify the corresponding programmable logical controller working in a factory environment so that it may take appropriate action when a failure occurs.

A common protocol that is used in the automation industry is the Modbus protocol. Originally designed as a serial line protocol in the late 1970s, it has become a de facto standard in the automation industry, and is used as a common interface between almost all intelligent automation devices. More recently, the Modbus protocol has be converted to work on Ethernet as Modbus/TCP. This protocol is also used by a number of automation vendors as a common interface. These protocols are defined in detail in the Modbus Application Protocol, version 1.1, December 2002 (this is a controlled document available at http://www.modbus.org) and in Modbus Messaging on TCP/IP Implementation Guide, version 1, May 2002 (this is a controlled document available at http://www.modbus.org), both documents hereby included by reference.

### SUMMARY OF INVENTION

It is an object of the invention to provide a protocol with provisions for a safety system.

In accordance with this object, a system and method are disclosed whereby the protocol provides a CRC-32 and time stamp fields to enhance the safety of Modbus/TCP messages.

### BRIEF DESCRIPTION OF DRAWINGS

FIG. 1 is a diagram of the system according to the present invention; and

FIG. 2 is a flow chart of the system according to a first embodiment of the present invention.

FIG. 3 is a flow chart of the system according to a second embodiment of the present invention.

FIG. 4 is a drawing of the Modbus/TCP protocol encryption.

FIG. 5 is a drawing of the encryption for the Safety Modbus/TCP message.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

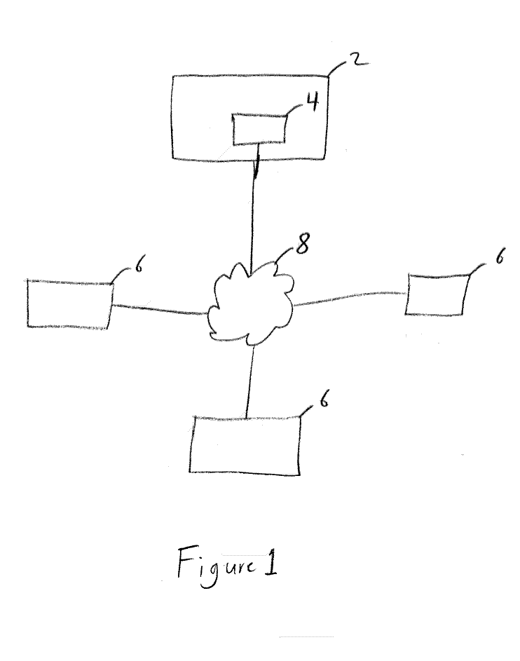

Referring to FIG. 1, there is shown a controller (PLC) 2 having an Ethernet communication board 4. The Ethernet communication board 4 is capable of sending and receiving network messages to and from any other device 6 on an Ethernet network 8, such as a transceiver, a personal computer, a data relay, other another PLC etc. The basic Ethernet communication board 4 used in the PLC is described in U.S. Pat. Nos. 6,061,603, 6,282,454, 6,327,511, 6,151,625, and U.S. patent application Ser. No. 09/477,113 the contents of such applications are hereby incorporated by reference.

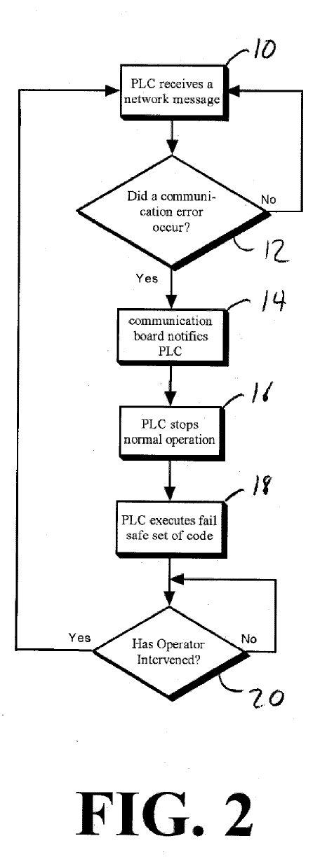

Referring to FIG. 2, in step 10 the Ethernet communication board 4 of the PLC 2 receives a network message. Network messages are transmitted between the PLC 2 and the other network devices 6. At step 12, the Ethernet communication board 4 determines whether a network communication error has occurred. The PLC 2 determines if there is a network communication error primarily by performing a CRC-32 check on the network message to determine is the message has been corrupted in transit by checking the logical data included in the network message header. In addition, the Modbus/TCP layer CRC-32 109 can also be checked to assure that the message has been reassembled by the TCP/IP stack correctly, and the timestamp 106 can be checked to see if the message had been timely received. If no network communication error has occurred in step 12, the PLC 2 returns to step 10 to process the next network message. If a network error has occurred, the PLC 2 advances to step 14. At step 14, the Ethernet communication board 4 notifies the PLC 2 that a network communication error has occurred. At step 16, in response to the notification the PLC 2 stops normal operation and advances to step 18. Normal operation is the operation of the PLC during which no network error has been detected. At step 18, the PLC executes a fail-safe set of code and advances to step 19. By way of example, the fail-safe set of code can be code which activates an alarm to notify personnel.

At step 19, the PLC fail-safe code determines if operator intervention is required. If operator intervention is required, the PLC advances to step 20. Otherwise, the PLC advances to step 10 to resume normal Ethernet network communication.

If operator intervention is required, at step 20, the PLC determines whether an operator has intervened. Operator intervention can be, for example, an operation clearing or acknowledging the alarm. If an operator has not intervened, the PLC 2 does not advance beyond step 20. If an operator has intervened, the PLC 2 advances to step 10 to continue normal Ethernet network communication.

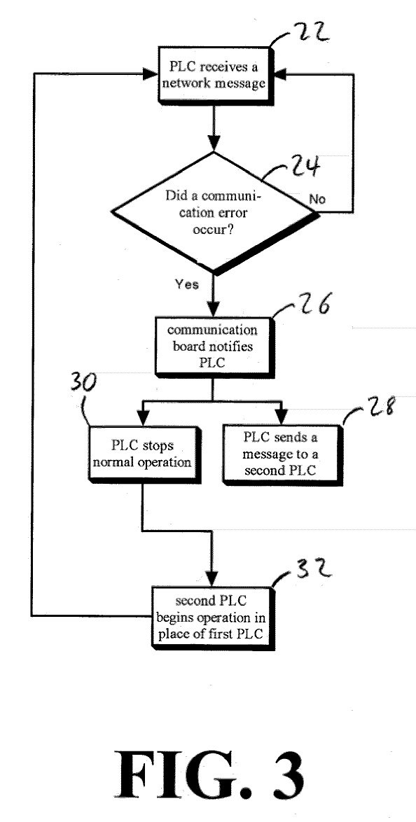

Referring to FIG. 3, in an alternative embodiment, the Ethernet communication board 4 of the PLC 2 receives a network message at step 22. At step 24, the Ethernet communication board 4 determines whether a network communication error has occurred. If no network error has occurred in step 24, the PLC 2 returns to step 22 to process the next network message. If a network error has occurred, the PLC 2 advances to step 26. At step 26, the Ethernet communication board 4 notifies the PLC 2 that a network communication error has occurred and advances to step 28. After step 28, in response to the notification the PLC 2 sends a message to a second PLC 6 operating on the network, and then the PLC 2 ceases sending and receiving messages on the network in step 30. In response to the message of step 28, the second PLC 6 begins operating on the network in place of the first PLC in step 32. The second PLC 6 mirrors the first PLC 2 and, therefore, can resume operation for the first PLC 2 without interruption to the process controlled by the first PLC 2. The second PLC 6 then begins sending and receiving network messages in place of the first PLC 2.

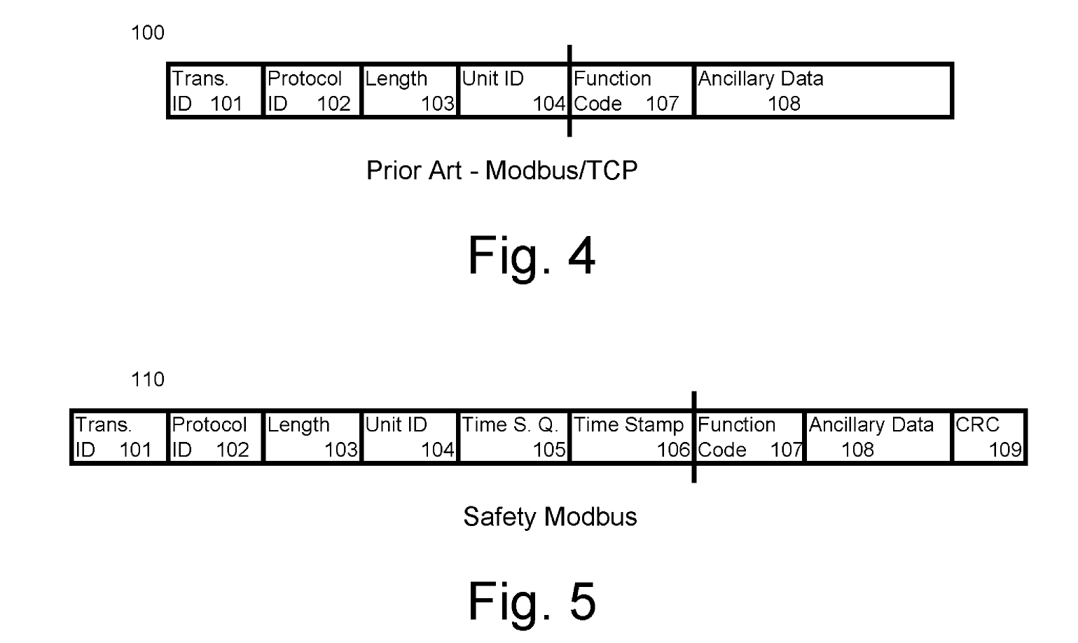

In FIG. 4, there is a drawing of a standard Modbus/TCP message 100. This message includes a Transaction ID 101 that consists of a 2 byte unsigned integer which uniquely represents a Modbus transaction. It further consists of a 2 byte integer Protocol Identifier 102 that is always set to 0 for standard Modbus/TCP messages. This is followed by a 2 byte Length field 103 that indicates the number of bytes to follow, including the Unit Identifier 104. The Unit Identifier 104 is a 1 byte number that identifies a remote unit on the other side of a gateway. The Function Code 107 is a 1 byte field that specifies the function of the Ancillary Data 108. The Ancillary Data 108 is a number of bytes as required by the Function Code 107. When this package is sent over a TCP/IP network, it is sent via the reserved system port 502 in the TCP/IP stack.

FIG. 5 is a drawing of the Safety Modbus protocol encryption 110. This encoding also includes a Transaction ID 101, a Length 103, a Unit Identifier 104, a Function Code 107 and Ancillary Data 108, as described above. The Protocol Identifier 102 is similarly a 2 byte field, with the hexadecimal value 7907 to specify this as a Safety Modbus message. In addition, there is a 1 byte Time Stamp Qualifier 105 after the Unit Identifier 104 that is used to qualify the Time Stamp 106 field to the Universal Time, Coordinated (UTC) time epoch rollover that will occur in the year 2036. Before the rollover the value is set to 0, indicating the AD 1900-2036 epoch is being represented. This field will be 1 for the 2036-2172 epoch, and incremented accordingly into the future. The Time Stamp 106 is an 8 byte field that will follow the Time Stamp Qualifier 105. The Time Stamp 106 will contain the UTC value indicating the time that the message is handed off to the sender's internal TCP/IP stack for transmission. Please see the Ethernet RFC 2030 (hereby included by reference) for a description of the UTC formats. After the Ancillary Data 108 there is a 4 byte Cyclic Redundancy Check (CRC) field 109 that contains the CRC value for the entire Safety Modbus 110 message with the exception of the CRC field. The CRC is calculated using the algorithm commonly known as CRC-32.

The CRC field 109 is used to check that the entire Modbus/TCP application layer message 110 has been received. There is a CRC-32 check that is done at the lower layers in the TCP/IP stack that validates the integrity of an individual message on the Ethernet wire, but this CRC-32 does not validate that the entire application layer message 110 has been received. The additional CRC field 109 adds further assurance that the full Modbus/TCP message 110 has been received from the source. Should the message fail a check of the CRC field 109, then the receiving device can institute corrective measures as outlined in FIGS. 2 and 3.

The timestamp field 106 along with its qualifier 105 are used to assure that the message 110 has been received from the source in a timely manner. The software in the receiving device can check that the message is received within a certain window of time. Should the message be received outside of this window, then the receiving device can institute corrective measures as outlined in FIGS. 2 and 3.

While the specific embodiments have been illustrated and described, numerous modifications come to mind without significantly departing from the spirit of the invention and the scope of protection is only limited by the scope of the accompanying claims.

1. A communications network between automation devices consisting:
an automation device capable of communicating using a TCP and an IP messaging technique,
whereby the messaging technique consists of sending a message to reserved TCP/IP system port 502,
and whereby said applications layer message includes a cyclic redundancy check field.

2. The communication network between automation devices of claim 1 whereby the cyclic redundancy check field is calculated using a CRC-32 algorithm.

3. The communication network between automation devices of claim 1 whereby the applications layer message further includes a time stamp representing the time that the message was sent.

4. The communication network between automation devices of claim 3 whereby the applications layer message further includes a time stamp qualifier.

5. A method of communicating between automation devices comprising
formulating an applications layer message that includes a cyclic redundancy check;
transmitting said message over an Ethernet network using a TCP/IP stack, whereby said message is sent to TCP/IP system port 502.

6. The method of communicating between automation devices in claim 5 whereby the cyclic redundancy check is calculated using a CRC-32 algorithm.

7. The method of communicating between automation devices in claim 5 further comprising the step of determining a time stamp and including said time stamp in the applications layer message.

8. The method of communicating between automation devices in claim 7 whereby the applications layer message further includes a time stamp qualifier.
